(19) United States
(12) Patent Application Publication
(10) Pub. No.: US 2008/0248303 A1
(43) Pub. Date: Oct. 9, 2008

(54) Post addition of amine-based compounds to reduce formaldehyde emmission in insulation products

(76) Inventor: Anthony L. Maurer, Alexandria, OH (US)

Correspondence Address: OWENS CORNING, 2790 COLUMBUS ROAD, GRANVILLE, OH, 43023, US

(21) Appl. No.: 11/784,723

(22) Filed: Apr. 9, 2007

(51) Int. Cl. D02G 3/00; B05D 3/12

(52) U.S. Cl. 428/378; 427/289; 427/292

(57) ABSTRACT

A method of reducing the emission of formaldehyde from fibrous insulation having thereon a formaldehyde-based binder is provided. In particular, an amine-based compound is added after the formaldehyde-based has been cured and prior to the insulation being processed for storage or shipment to customers. The amine-based compound may be added after binder cure and either prior to the insulation product being cut into nodules or after the insulation product has been cut into nodules. Non-limiting examples of amine-based compounds include urea, melamine and/or dicyandiamide. Once applied to the insulation product, the amine-based compound acts as a formaldehyde scavenger to reduce the emission of formaldehyde into the air. In preferred embodiments, the amine-based compound is added with an antistatic agent. The post-cure addition of urea to fibrous insulation reduces the emission of formaldehyde into the atmosphere to meet stringent GREENGUARD standards and achieve GREENGUARD certification for formaldehyde emission.

### TECHNICAL FIELD AND INDUSTRIAL

1. Applicability of the Invention

The present invention relates generally to fiberglass insulation, and more particularly, to the addition of an amine-based compound to fiberglass insulation after curing the formaldehyde-based binder in the fiberglass insulation to reduce the release of formaldehyde into the atmosphere.

2. Background of the Invention

Conventional fibers are useful in a variety of applications including reinforcements, textiles, and acoustical and thermal insulation materials. Fibrous insulation is typically manufactured by fiberizing a molten composition of a polymer, glass, or other mineral and spinning fine fibers from a fiberizing apparatus, such as a rotating spinner. Although mineral fibers (e.g., glass fibers) are typically used in insulation products, depending on the particular application, organic fibers such as polypropylene, polyester, and multicomponent fibers may be used alone or in combination with mineral fibers in forming the insulation product.

To form an insulation product, fibers produced by the rotating spinner are drawn downwardly from the spinner towards a conveyor by a blower. As the fibers move downward, a binder material is sprayed onto the fibers and the fibers are collected into a high loft, continuous blanket on the conveyor. The binder material gives the insulation product resiliency for recovery after packaging and provides stiffness and handleability so that the insulation product can be handled and applied as needed in the insulation cavities of buildings. The binder composition also provides protection to the fibers from interfilament abrasion and promotes compatibility between the individual fibers.

The blanket containing the binder-coated fibers is then passed through a curing oven and the binder is cured to set the blanket to a desired thickness. After the binder has cured, the fiber insulation may be cut into lengths to form individual insulation products, and the insulation products may be packaged for shipping to customer locations. One typical insulation product produced is an insulation batt or blanket, which is suitable for use as wall insulation in residential dwellings or as insulation in the attic and floor insulation cavities in buildings. Another common insulation product is air-blown or loose-fill insulation, which is suitable for use as sidewall and attic insulation in residential and commercial buildings as well as in any hard-to-reach locations. Loose-fill insulation is formed of small cubes that are cut from insulation blankets, compressed, and packaged in bags.

Formaldehyde-based binders such as phenol-formaldehyde binders have been widely used in the past in the manufacture of glass fiber insulation products because they have a low viscosity in an uncured state yet form a rigid thermoset polymeric matrix for the glass fibers when cured. However, formaldehyde-based binders release a significant amount of formaldehyde into the environment while the binder is being cured. In addition, formaldehyde may be released from the cured binder, especially when the cured binder is exposed to humid environments. Formaldehyde is toxic by inhalation, a strong irritant, and a possible carcinogen. Therefore, formaldehyde release into the air is undesirable, particularly in enclosed spaces, because the formaldehyde may be inhaled by workers, or it may come into contact with a part of the body.

Various attempts have been made to reduce formaldehyde emissions from formaldehyde-based resins. For example, various formaldehyde scavengers such as ammonia and urea have been added to the formaldehyde-based resin in an attempt to reduce formaldehyde emission from the insulation product. Because of its low cost, urea is added directly to the uncured resin system to act as a formaldehyde scavenger. The addition of urea to the resin system produces urea-extended phenol-formaldehyde resole resins. These resole resins can be further treated or applied as a coating or binder and then cured. Unfortunately, the urea-extended resoles are unstable, and because of this instability, the urea-extended resoles must be prepared on site. In addition, the binder inventory must be carefully monitored to avoid processing problems caused by undesired crystalline precipitates of dimer species that may form during storage. Ammonia is not a particularly desirable alternative to urea as a formaldehyde scavenger because ammonia generates an unpleasant odor and may cause throat and nose irritation to workers. Further, the use of a formaldehyde scavenger in general is undesirable due to its potential adverse affects to the properties of the insulation product, such as lower recovery and lower stiffness.

Alternative polymeric binder systems for fibrous glass products have also been proposed. However, low molecular weight, low viscosity binders which allow maximum vertical expansion of the mat in the transfer zone generally cure to form a non-rigid plastic matrix in the finished product, thereby reducing the attainable vertical height recovery of the finished insulation product when installed. Conversely, high viscosity binders, which generally cure to form a rigid matrix in the finished product, do not allow the desired maximum vertical expansion of the coated, uncured mat.

Thus, there remains a need in the art for a method to reduce or eliminate the emission of formaldehyde from insulation products.

### SUMMARY OF THE INVENTION

It is an object of the present invention to provide a method of reducing the emission of formaldehyde from loose-fill fibrous insulation. Inorganic fibers of random lengths are formed and at least partially coated with a formaldehyde-based binder composition. Non-limiting examples of inorganic fibers include glass fibers, wool glass fibers, and/or ceramic fibers. Glass fibers are the most preferred inorganic fiber for use in the present invention. The inorganic fibers are gathered and formed into an uncured insulation batt on an endless forming conveyor within a forming chamber. The insulation batt is then heated to evaporate any remaining water in the binder, cure the binder, and rigidly bond the fibers together and form an insulation blanket.

In one exemplary embodiment, the insulation blanket may be fed into a cutting apparatus to form nodules having a cubed or substantially cubed shape. The insulation nodules may have a size from about ¼ of an inch to about 1 inch in any width, length, or height direction. Alternatively, the insulation blanket may be milled to produce small nodules that are typically non-uniform in size and shape. After the insulation blanket has been chopped into nodules, an amine-based compound such as urea is applied to the nodules by a suitable application device. In an alternate embodiment, the amine-based compound is applied to the insulation blanket prior to forming the insulation nodules. Preferably, the amine-based compound is urea. Other examples of amine-based compounds suitable for application include ammonia, melamine, dicyandiamide, and polyamides. The amine-based compound may be applied to one or more surfaces of the insulation blanket. In addition, the amine-based compound may be in either a solid or an aqueous form, and is preferably added in an amount from about 0.1 to about 3.0% by weight of the inorganic fibers. In preferred embodiments, the amine-based compound is added with an antistatic agent. It has been discovered that the post-cure addition of urea to fibrous insulation containing a formaldehyde-based binder reduces the emission of formaldehyde into the atmosphere and meets stringent GREENGUARD standards to achieve GREENGUARD certification for formaldehyde emission.

It is another object of the present invention to provide a method of reducing the emission of formaldehyde from faced fibrous insulation products. Initially, an insulation blanket may be formed by collecting inorganic fibers on a foraminous conveyor to form an insulation batt. The insulation batt may be heated in an oven to cure the formaldehyde-based binder present on the inorganic fibers and bond the fibers together to form an insulation blanket. Non-limiting examples of inorganic fibers that may be used to form the insulation blanket include glass fibers, wool glass fibers, and ceramic fibers. Glass fibers are the preferred inorganic fiber. The insulation blanket has two major surfaces, e.g., a top and bottom surface, and two minor or side surfaces. An amine-based compound is added to one or more surfaces of the insulation blanket after exiting the oven and prior to placing a facing material onto at least one of the major surfaces the insulation blanket. Suitable amine-based compounds that may be applied to the insulation blanket include urea, ammonia, melamine, dicyandiamide, and polyamides. Urea is the preferred amine-based compound. After the application of the amine-based compound, a facing material is placed on the insulation blanket to form a faced insulation product. Such a faced insulation product may be used, for example, as panels in basement finishing systems, as ductwrap, ductboard, as faced residential insulation, and as pipe insulation. The post-cure addition of urea to fibrous insulation reduces the emission of formaldehyde into the atmosphere and meets stringent GREENGUARD standards to achieve GREENGUARD certification for formaldehyde emission.

It is yet another object of the present invention to provide a loose-fill insulation product that is formed of an insulation nodule formed of a plurality of inorganic fibers at least partially coated with a cured formaldehyde-based binder and an amine-based compound at least partially coating one or more surfaces of the insulation nodule. The amine-based compound is desirably selected from aqueous urea, solid urea, melamine, dicyandiamide or mixtures thereof. In a most preferred embodiment, the amine-based compound is urea. In addition, the amine-based compound may be present on one or more surfaces of the insulation nodule in an amount from 0.1 to about 3.0% by weight of the inorganic fibers. Non-limiting examples of inorganic fibers that may be used to form the insulation nodule include glass fibers, wool glass fibers, and/or ceramic fibers. Glass fibers are the preferred inorganic fiber.

It is an advantage of the present invention that the addition of an amine-based compound after curing a formaldehyde-based binder present on the fibers of an insulation product significantly reduces formaldehyde emission into the atmosphere.

It is another advantage of the present invention that formaldehyde emission from insulation products can be reduced and worker safety can be improved at a low cost to the manufacturer due to the low price of amine-based compounds.

It is a further advantage of the present invention that by lowering the formaldehyde emission from insulation products, the overall volatile organic compounds (VOCs) emitted in the workplace are reduced and the workplace becomes a safer environment.

It is yet another advantage of the present invention that adding an amine-based compound such as urea after the formaldehyde-based binder has been cured reduces the emission of particulates and formaldehyde decomposition products into the atmosphere compared to adding urea prior to the insulation blanket being cured.

It is a feature of the present invention that the post-cure addition of urea to the insulation product reduces formaldehyde emission to a level acceptable to achieve GREENGUARD certification.

It is another feature of the present invention that the amine-based compound added to the insulation product acts as a formaldehyde scavenger to reduce the release of formaldehyde into the air.

The foregoing and other objects, features, and advantages of the invention will appear more fully hereinafter from a consideration of the detailed description that follows.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of the formation of loose-fill fibrous insulation with a post-cure application of urea onto the loose-fill insulation nodules;

FIG. 2 is a schematic illustration of the formation of loose-fill fibrous insulation with a post-cure application of urea onto the insulation blanket prior to cutting the blanket into loose-fill insulation nodules;

FIG. 3 is a schematic illustration of the formation of a faced insulation product with a post-cure application of urea onto the insulation blanket prior to the application of a facing layer; and

FIG. 4 is a graphical illustration of the mean formaldehyde emissions and 95% confidence intervals for the samples tested both with and without the addition of urea.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity. It will be understood that when an element such as a layer, region, substrate, or panel is referred to as being “on” another element, it can be directly on the other element or intervening elements may also be present. Also, when an element is referred to as being “adjacent” to another element, the element may be directly adjacent to the other element or intervening elements may be present. The terms “top”, “bottom”, “side”, and the like are used herein for the purpose of explanation only. It is to be noted that like numbers found throughout the figures denote like elements.

The present invention relates to the addition of at least one amine-based compound to fibrous insulation to reduce or eliminate the emission of formaldehyde into the atmosphere. In particular, an amine-based compound is added to an insulation product after the formaldehyde-based binder has been cured. One example of a formaldehyde-based binder is a phenol-formaldehyde binder. Non-limiting examples of amine-based compounds for use in the present invention include urea, ammonia, melamine, dicyandiamide, polyamides, and mixtures thereof. Once applied to the insulation product, the amine-based compound acts as a formaldehyde scavenger to reduce the emission of formaldehyde into the air. A preferred amine-based compound utilized in the present invention is urea. In at least one exemplary embodiment, amine-based compound is added after the formaldehyde-based binder on the fibers in an insulation product has been cured and prior to the insulation being processed for storage or shipment to the customer. The amine-based compound may be added to the insulation product in either a solid or aqueous form. In addition, the post-cure addition of urea to fibrous insulation reduces the emission of formaldehyde into the atmosphere to meet stringent GREENGUARD standards and achieve GREENGUARD certification for formaldehyde emission. For ease of discussion, the invention will be discussed herein with reference to urea, a preferred amine-based compound. It is to be appreciated, however, that any amine-based compound capable of behaving as a formaldehyde scavenger may alternatively be utilized.

Fibrous insulation products are generally formed of matted inorganic fibers bonded together by a cured thermoset polymeric material. Examples of suitable inorganic fibers include glass fibers, wool glass fibers, and ceramic fibers. Insulation products may be formed entirely of one type of fiber, or they may be formed of a combination of types of fibers. For example, the insulation product may be formed of combinations of various types of glass fibers or various combinations of different inorganic fibers depending on the desired application for the insulation. The embodiments described herein are with reference to insulation products formed entirely of glass fibers.

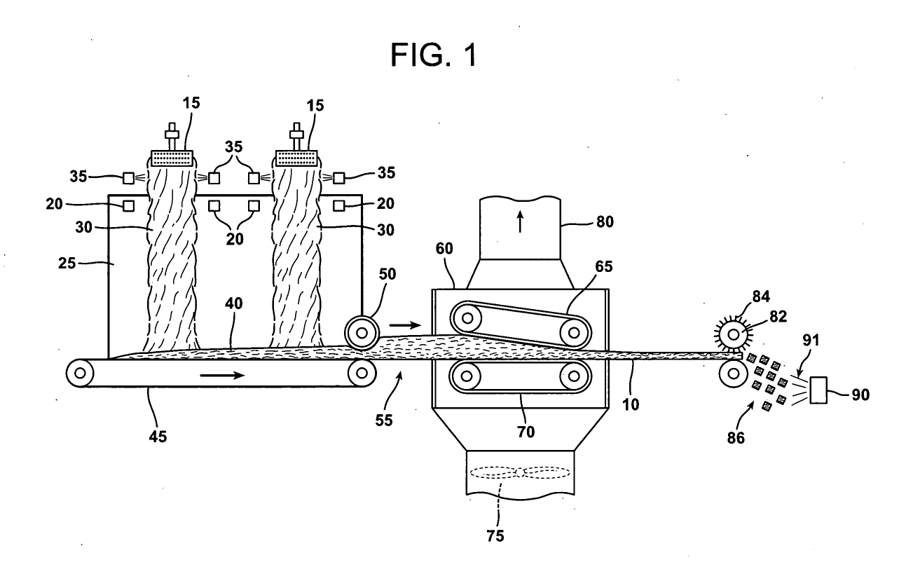

The manufacture of glass fiber insulation may be carried out in a continuous process by fiberizing molten glass, immediately forming a fibrous glass batt on a moving conveyor, and curing the binder on the fibrous glass insulation batt to form an insulation blanket as depicted in FIG. 1. Glass may be melted in a tank (not shown) and supplied to a fiber forming device such as a fiberizing spinner 15. The spinners 15 are rotated at high speeds. Centrifugal force causes the molten glass to pass through holes in the circumferential sidewalls of the fiberizing spinners 15 to form glass fibers. Glass fibers 30 of random lengths may be attenuated from the fiberizing spinners 15 and blown generally downwardly, that is, generally perpendicular to the plane of the spinners 15, by blowers 20 positioned within a forming chamber 25. It is to be appreciated that the glass fibers 30 may be the same type of glass or they may be formed of different types of glass. It is also within the purview of the present invention that at least one of the fibers 30 formed from the fiberizing spinners 15 is a dual glass fiber where each individual fiber is formed of two different glass compositions.

The blowers 20 turn the fibers 30 downward to form a fibrous batt 40. The glass fibers 30 may have a diameter from about 2 to about 9 microns and a length from about ¼ of an inch to about 4 inches. Preferably, the glass fibers have a diameter from about 3 to about 6 microns and a length from about ½ of an inch to 1½ inches. The small diameter of the glass fibers 30 helps to give the final insulation product a soft feel and flexibility.

The glass fibers 30, while in transit in the forming chamber 25 and while still hot from the drawing operation, are sprayed with an aqueous formaldehyde-based binder composition by suitable spray applicators 35 so as to result in a distribution of the formaldehyde-based binder composition throughout the formed batt 40 of fibrous glass. One example of a formaldehyde-based binder is a phenol-formaldehyde binder. The binder may include ingredients such as an organosilane, glycerol, lignin, pH modifiers, oil emulsions, and/or active and latent catalysts. Water may also be applied to the glass fibers 30 in the forming chamber 25, such as by spraying, prior to the application of the formaldehyde-based binder composition to at least partially cool the glass fibers 30. The binder may be present in an amount from less than or equal to about 10% by weight, and preferably in an amount less than or equal to about 3% by weight of the total product. The low amount of binder contributes to the flexibility of the final insulation product.

The glass fibers 30 having the uncured resinous binder adhered thereto may be gathered and formed into an uncured insulation batt 40 on an endless forming conveyor 45 within the forming chamber 25 with the aid of a vacuum (not shown) drawn through the fibrous mat 40 from below the forming conveyor 45. The residual heat from the glass fibers 30 and the flow of air through the fibrous mat 40 during the forming operation are generally sufficient to volatilize a majority of the water from the binder before the glass fibers 30 exit the forming chamber 25, thereby leaving the remaining components of the binder on the fibers 30 as a viscous or semi-viscous high-solids liquid.

The coated fibrous mat 40, which is in a compressed state due to the flow of air through the mat 40 in-the forming chamber 25, is then transferred out of the forming chamber 25 under exit roller 50 to a transfer zone 55 where the mat 40 vertically expands due to the resiliency of the glass fibers. The expanded insulation batt 40 is then heated, such as by conveying the batt 40 through a curing oven 60 where heated air is blown through the insulation batt 40 to evaporate any remaining water in the binder, cure the binder, and rigidly bond the fibers together. Heated air is forced though a fan 75 through the lower oven conveyor 70, the insulation batt 40, the upper oven conveyor 65, and out of the curing oven 60 through an exhaust apparatus 80. The cured binder imparts strength and resiliency to the insulation blanket 10. It is to be appreciated that the drying and curing of the binder may be carried out in either one or two different steps. The two stage (two-step) process is commonly known as B-staging.

Also, in the curing oven 60, the insulation batt 40 may be compressed by upper and lower foraminous oven conveyors 65, 70 to form a fibrous insulation blanket 10. It is to be appreciated that the insulation blanket 10 has an upper surface and a lower surface. In particular, the insulation blanket 10 has two major surfaces, typically a top and bottom surface, and two minor or side surfaces with fiber blanket 10 oriented so that the major surfaces have a substantially horizontal orientation. The upper and lower oven conveyors 65, 70 may be used to compress the insulation batt 40 to give the insulation blanket 10 a predetermined thickness. The curing oven 60 may be operated at a temperature from about 200° C. to about 325° C. Preferably, the temperature of the curing oven ranges from about 250° C. to about 300° C. The insulation batt 40 may remain within the oven for a period of time sufficient to crosslink (cure) the binder and form the insulation blanket 10. In particular, the insulation batt 40 may remain in the oven 60 for about 30 seconds to about 3 minutes, and preferably for about 45 seconds to about 1½ minutes to cure the binder. The insulation blanket 10 exiting the curing oven 60 may have a density from about 0.3 pcf to about 4.0 pcf and a thickness of approximately 1 to 12 inches. The insulation blanket 10 may be cut into desired lengths and widths and rolled into insulation packages (not shown) for storage or for shipping to consumers.

A significant portion of the insulation placed in the insulation cavities of buildings is in the form of insulation blankets rolled from insulation packages such as is described above. By way of contrast, in some insulation applications, small nodules of loose-fill insulation are pneumatically blown into wall cavities, attic cavities, and any hard-to-reach locations needing insulation. In forming loose-fill insulation, the insulation blanket 10 may be fed into a cutting apparatus 82 having a plurality of blades 84 which cut the fibrous insulation blanket 10 into nodules 86 having a cubed or substantially cubed shape. The nodules 86 preferably have a size from about ¼ of an inch to about 1 inch in any width, length, or height direction. The loose-fill insulation nodules 86 are desirably substantially the same size. In an alternate embodiment, the insulation blanket 10 may be milled (not shown) to produce small nodules of the insulation blanket 10. When the blanket 10 is milled, the nodules tend to be non-uniform in shape and size.

After the insulation blanket 10 is chopped, urea 91 is applied to the nodules 86 by a suitable application device 90. The urea 91 may be applied directly to the surface of the nodules 86. In FIG. 1, the application device 90 is a spraying device for applying an aqueous form of urea (e.g., a urea solution) to at least a portion of the surfaces of the loose-fill insulation nodules 86. It is to be appreciated that any device suitable for the application of an aqueous urea solution may be utilized and would be identifiable to those of skill in the art. Alternatively, solid urea such as prilled urea may be applied to the surface of the nodules 86 by a suitable application device (not shown). Other types of solid urea such as urea granules, flakes, or pellets may be applied to the surfaces of the nodules 86. Solid feeders that are based on an auger or a vibratory-type feeder may be used to disperse the solid urea onto the insulation nodules 86. After the urea 91 is applied to the nodules 86, the nodules 86 are collected and delivered to a bagging apparatus which places the nodules 86 into a bag (not illustrated). Any conventional bagging apparatus may be utilized to collect the nodules 86 for shipping. In use, the loose-fill insulation nodules 86 may be poured or pneumatically conveyed or blown to or into a desired location.

In preferred embodiments, the urea 91 is added with an antistatic agent. The antistatic agent may be a mineral oil, quaternary ammonium salts (e.g., behentrimonium chloride and cocamidopropyl betaine), long-chain aliphatic amines (optionally ethoxylated), long-chain aliphatic amides, esters of phosphoric acid, polyethylene glycol esters, polyols, and combination thereof. The antistatic agent may be included as a component in the aqueous urea solution and applied to the nodules 86 via applicator 90 or it may be applied to the loose-fill insulation 86 by a separate applicator (not shown). The antistatic agent may be separately applied by traditional methods such as dilution with water, followed by spraying onto the cut loose-fill insulation nodules 86.

The urea 91, either in solid or liquid form, may be added to the insulation nodules 86 in an amount from about 0.1 to about 3.0% by weight of the glass, preferably in an amount from about 1.0 to about 1.5% by weight of the glass. The post-cure addition of urea 91 to the loose-fill insulation nodules 86 reduces formaldehyde emission from the insulation in an amount sufficient to meet the stringent requirements of GREENGUARD and achieve a GREENGUARD certification for the emission of formaldehyde.

After the application of urea 91, the loose-fill insulation nodules 86 are collected and delivered to a hopper of a bagging apparatus (not shown) for bagging and shipment to customers or for storage for later use. The loose-fill insulation nodules 86 are packaged in a container (e.g., a bag) and compressed to a density of about 8.0 to about 12 pcf, and more preferably, to a density of about 9.0 to about 11.0 pcf. It is to be appreciated that the formation of the insulation blanket 10 and the loose-fill insulation nodules 86 may be formed in-line (as depicted in FIG. 1) or off-line in separate steps (not shown). Desirably, the formation of the loose-fill insulation 86 is formed in-line with the formation of the insulation blanket 10.

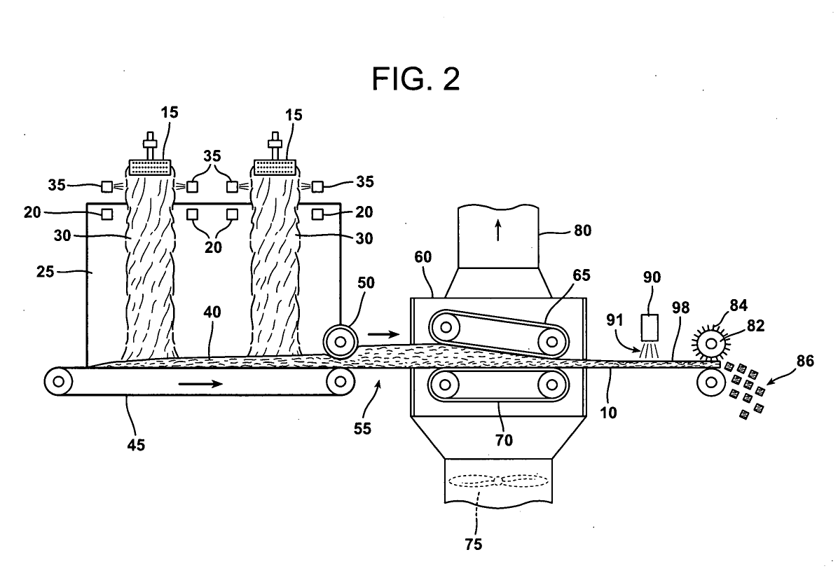

In an alternate embodiment shown in FIG. 2, the urea 91 is added to the insulation blanket 10 after exiting the oven 60 and prior to either rolling the insulation for storage or shipping (not illustrated) or chopping the insulation blanket 10 into loose-fill insulation nodules 86 by the cutting apparatus 82. The urea 91 may be added in a solid or an aqueous form, and it may be applied to one or more of the major or minor surfaces of the insulation blanket 10. In the embodiment depicted in FIG. 2, the urea 91 is applied by an aqueous applicator 90 to a first major surface of the blanket 10 to form a urea-coated insulation blanket 98. It is within the purview of the invention to coat or partially coat one or both major surface and/or one or both minor surfaces of the insulation blanket 10 with urea 91. Thus, the insulation nodules 86 formed from the urea-coated insulation blanket 98 have at least one surface partially or completely coated with urea 91.

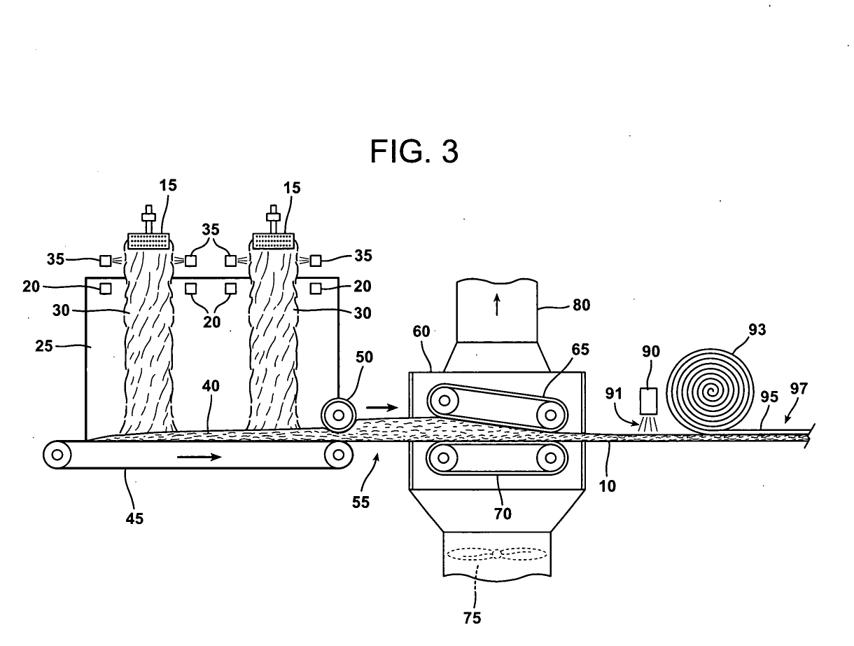

In yet another alternate embodiment depicted in FIG. 3, the urea 91 is added to the insulation blanket 10 after exiting the oven 60 and prior to placing a facing material 95 onto at least one of the major surfaces the insulation blanket 10. In many cases, the facing acts as a vapor barrier, and in some insulation products, the facing gives the product integrity for handleability. As shown in FIG. 3, formaldehyde binder-coated glass fibers 30 are deposited onto a moving conveyor 45 with the aid of blowers 20 positioned within the forming chamber 25 to form a fibrous mat 40. The fibrous mat 40 is passed under exit roller 50 to a transfer zone 55 where the mat 40 vertically expands. The fibrous mat 40 is then conveyed through a curing oven 60 where heated air is blown through the fibrous mat 40 to evaporate any remaining water in the binder, cure the binder, and rigidly bond the fibers together. As described above with reference to FIGS. 1 and 2, heated air is forced though a fan 75 through the lower oven conveyor 70, the fibrous mat 40, the upper oven conveyor 65, and out of the curing oven 60 through an exhaust apparatus 80 to cure the binder.

The urea 91 is applied to the insulation blanket 10 after it exits the oven 60. An aqueous applicator 90 is utilized to apply a liquid solution of urea as discussed above. A solid form of urea may alternatively be applied to the insulation blanket 10 (not shown). A facing material 93 is then placed on the insulation blanket 10 to form a facing layer 95. Non-limiting examples of suitable facing materials 93 include Kraft paper, a foil-scrim-Kraft paper laminate, recycled paper, and calendared paper. The facing material 93 may be adhered to the surface of the insulation blanket 10 by a bonding agent (not shown) to form a faced insulation product 97. Suitable bonding agents include adhesives, polymeric resins, asphalt, and bituminous materials that can be coated or otherwise applied to the facing material 93. Such a faced insulation product 97 may be used, for example, as panels in basement finishing systems, as ductwrap ductboard, as faced residential insulation, and as pipe insulation.

There are numerous advantages of adding an amine-based compound to fibrous insulation after the formaldehyde-based binder has been cured. For example, the addition of the amine-based compound reduces the formaldehyde emission from the insulation product in an amount sufficient to meet GREENGUARD standards and achieve GREENGUARD certification. By lowering formaldehyde emission, the overall volatile organic compounds (VOCs) emitted in the workplace are reduced, and the workplace becomes a safer environment. Additionally, because amine-based compounds are relatively inexpensive, formaldehyde emission from the insulation product can be reduced or eliminated and worker safety can be improved at a low cost to the manufacturer.

In addition, adding an amine-based compound such as urea after the formaldehyde-based binder has been cured reduces the emission of particulates and degradation products into the atmosphere compared to adding urea prior to the binder being cured. As urea is heated in the oven, it may become fugitive. For example, the urea may decompose, boil off, or sublime, resulting in the undesirable and potential harmful emission of formaldehyde particulates and decomposition products into the environment.

Having generally described this invention, a further understanding can be obtained by reference to certain specific examples illustrated below which are provided for purposes of illustration only and are not intended to be all inclusive or limiting unless otherwise specified.

### EXAMPLES

Cubed glass insulation nodules having a size of ½ of an inch per side and including 4.5% by weight of a formaldehyde binder were obtained for testing. Insulation nodules having no added urea (control), prilled urea, water, or a solution of urea in the amounts shown in Table 1 were placed into 5.75 inch diameter straight walled evaporation dishes. The urea solution was made by adding 50 grams of prilled urea and 50 grams of water in a container. The sample weights were recorded. Two 50 ml beakers filled with deionized water were placed on either side of the samples in desiccators. The desiccators were then closed and the time was recorded.

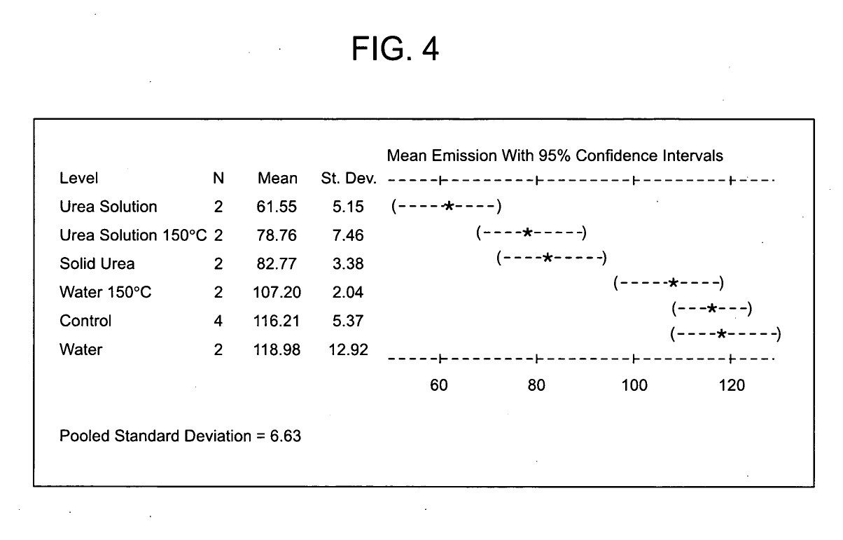

After 24 hours, the desiccators were opened and the beakers of water from each of the desiccators were removed and poured into 2 oz large mouth plastics bottles for formaldehyde emission testing 0.05 ml of 1000 ppm dodecyl trimethyl ammonium chloride in water (e.g., biocide) was added to each of the plastic bottles. The water samples were submitted to the Organic Analytical Lab to determine the formaldehyde emission of the samples. The testing parameters and test results are set forth in Table 1 and FIG. 4.

TABLE 1

| | | | Sample | | |
|---|---|---|---|---|---|
| | | Urea | Weight | HCOH | μg/m²- |
| Sample | Comments | Addition | (gm) | (μg) | hr |
| 1 | Control | 0.0% | 19.98 | 48.03 | 119.44 |
| 2 | Control | 0.0% | 20.02 | 49.04 | 121.96 |
| 3 | Prilled urea | 1.0% | 20.21 | 34.24 | 85.16 |
| 4 | Prilled urea | 1.0% | 20.20 | 32.32 | 80.38 |
| 5 | Control | 0.0% | 20.00 | 45.40 | 112.91 |
| 6 | Control | 0.0% | 19.99 | 44.44 | 110.53 |
| 7 | Water | 0.0% | 20.18 | 44.16 | 109.84 |
| 8 | Water | 0.0% | 20.36 | 51.51 | 128.11 |
| 9 | Water - then dried | 0.0% | 20.27 | 42.52 | 105.75 |
| | for 60 minutes at | | | | |
| | 150° C. | | | | |
| 10 | Water - then dried | 0.0% | 20.46 | 43.68 | 108.64 |
| | for 60 minutes at | | | | |
| | 150° C. | | | | |
| 11 | 50% urea solution | 2.9% | 20.44 | 26.21 | 65.19 |
| 12 | 50% urea solution | 3.1% | 20.44 | 23.28 | 57.90 |
| 13 | 50% urea solution - | 2.6% | 20.24 | 33.78 | 84.03 |
| | then dried for 60 | | | | |
| | minutes at 150° C. | | | | |
| 14 | 50% urea solution - | 2.8% | 20.47 | 29.54 | 73.48 |
| | then dried for 60 | | | | |
| | minutes at 150° C. | | | | |

The samples were tested for formaldehyde emission. It can be concluded from Table 1 that the addition of water, either with or without post drying, had no effect on the formaldehyde being emitted from the insulation nodules. On the other hand, the addition of solid prilled urea lowered formaldehyde emission by an amount of 29% (calculated on a weight basis). For example, the average of the four Controls (i.e., Samples 1, 2, 5, and 6) is 116.21 μg/m²-hr and the average of the 2 prilled urea samples is 82.77 μg/m²-hr. Thus, the addition of prilled urea to the insulation nodules lowered the formaldehyde emission by 33.44 μg/m²-hr (i.e., 116.21 μg/m²-hr-82.77 μg/m²-hr). The percent improvement is calculated as (33.44 μg/m²-hr divided by 116.21 μg/m²-hr) times 100 equals 29%. It can further be concluded from Table 1 that the addition of a urea solution lowered formaldehyde emission by 47% (calculated on a weight basis) and that the addition of a urea solution followed by drying lowered the formaldehyde emission from the insulation nodules by 32% (calculated on a weight basis). Although not wishing to be bound by theory, it is believed that the difference between the 47% reduction of formaldehyde emission with the addition of a urea solution and the 32% reduction of formaldehyde by the addition of a urea solution followed by drying is due to a loss of urea caused by decomposition and/or sublimation.

FIG. 4 is the output from a statistical analysis program used to determine whether any of the various treatments (e.g., solid urea, urea solution, and water) to the insulation nodules are statistically different. An Analysis of Variance (ANOVA) was used to determine that a difference of 15 between mean emission levels is statistically significant at 95% confidence. Looking at FIG. 4, it can be seen that the addition of solid urea, aqueous urea, and aqueous urea followed by drying are all significantly better than the control. It can be further concluded from FIG. 4 that the addition of aqueous urea without subsequent drying is statistically better than either the addition of aqueous urea followed by drying or the addition of solid urea. It can be concluded from this analysis that the preferable application method is to apply urea to the insulation without subsequent drying.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of reducing the emission of formaldehyde from loose-fill fibrous insulation comprising:
curing a formaldehyde-based binder on glass fibers forming an insulation blanket to form a cured insulation blanket, said formaldehyde-based binder at least partially coating said glass fibers;
applying an amine-based compound to at least a portion of said cured insulation blanket; and
dividing said cured insulation blanket into insulation nodules;
wherein said amine-based compound acts as a formaldehyde scavenger to reduce the release of formaldehyde into the air.

2. The method of claim 1, wherein said dividing step comprises:
cutting said cured insulation blanket into insulation nodules prior to applying said amine-based compound, said amine-based compound being applied to one or more surfaces of said insulation nodules.

3. The method of claim 1, wherein said dividing step comprises:
cutting said cured insulation blanket into insulation nodules after applying said amine-based compound, said amine-based compound being located on at least one surface of said insulation nodules.

4. The method of claim 1, further comprising:
forming glass fibers having random lengths;
applying said formaldehyde-based binder to at least a portion of said glass fibers; and
collecting said glass fibers to form said insulation blanket.

5. The method of claim 1, wherein said amine-based compound is selected from aqueous urea, solid urea, melamine, dicyandiamide and mixtures thereof.

6. The method of claim 5, wherein said amine-based compound is applied with an anti-static agent.

7. The method of claim 5, wherein said amine-based compound is applied in an amount from about 0.1 to about 3.0% by weight of said glass fibers.

8. The method of claim 1, wherein said application of said amine-based compound reduces formaldehyde emission in an amount sufficient to achieve a GREENGUARD certification for the emission of formaldehyde.

9. A method of reducing the emission of formaldehyde from faced fibrous insulation products comprising:
curing a formaldehyde-based binder on inorganic fibers forming an insulation blanket to form a cured insulation blanket, said formaldehyde-based binder at least partially coating said inorganic fibers;
applying an amine-based compound to at least a portion of said cured insulation blanket to form a coated blanket;
wherein said amine-based compound acts as a formaldehyde scavenger to reduce the release of formaldehyde from said coated blanket.

10. The method of claim 9, wherein said inorganic fibers are selected from glass fibers, wool glass fibers, ceramic fibers and combinations thereof.

11. The method of claim 10, wherein said amine-based compound is selected from aqueous urea, solid urea, melamine, dicyandiamide and mixtures thereof.

12. The method of claim 11, further comprising:
forming glass fibers having random lengths;
applying said formaldehyde-based binder to at least a portion of said glass fibers; and
collecting said glass fibers to form said insulation blanket.

13. The method of claim 9, wherein said amine-based compound is applied to said cured insulation blanket in an amount from about 0.1 to about 3.0% by weight of said glass.

14. The method of claim 9, wherein said application of said amine-based compound reduces formaldehyde emission in an amount sufficient to achieve a GREENGUARD certification for the emission of formaldehyde.

15. The method of claim 9, further including the step of attaching a facing to at least one surface of said coated blanket.

16. A loose-fill insulation product comprising:
an insulation nodule formed of a plurality of inorganic fibers at least partially coated with a cured formaldehyde-based binder, said insulation nodule having a plurality of surfaces; and
an amine-based compound at least partially coating one or more surfaces of said insulation nodule.

17. The loose-fill insulation product of claim 16, wherein said amine-based compound is selected from aqueous urea, solid urea, melamine, dicyandiamide and mixtures thereof.

18. The loose-fill insulation product of claim 16, wherein said inorganic fibers are selected from glass fibers, wool glass fibers, ceramic fibers and combinations thereof.

19. The loose-fill insulation product of claim 16, wherein said insulation nodule is cubed or substantially cubed in shape.

20. The loose-fill insulation product of claim 16, further comprising an anti-static agent on at least one surface of said insulation nodule.

21. The loose-fill insulation product of claim 16, wherein said amine-based compound is present on said one or more surfaces of said insulation nodule in an amount from 0.1 to about 3.0% by weight of said inorganic fibers.
